(19) United States
(12) Patent Application Publication
(10) Pub. No.: US 2005/0057221 A1
(43) Pub. Date: Mar. 17, 2005

(54) Electrical connecting device for rechargeable electrochemical energy storage system

(76) Inventors: Hans Desilvestro, Auckland (NZ); Ibrahim Karim, Auckland (NZ)

Correspondence Address: FACTOR & LAKE, LTD, 1327 W. WASHINGTON BLVD., SUITE 5G/H, CHICAGO, IL, 60607, US

(21) Appl. No.: 10/737,159

(22) Filed: Dec. 16, 2003

Related U.S. Application Data
(60) Provisional application No. 60/435,322, filed on Dec. 19, 2002.

(51) Int. Cl. H02J 7/00

(52) U.S. Cl. 320/119

(57) ABSTRACT

The present invention is drawn to an electrical connecting device for rechargeable electrochemical energy storage systems, comprising at least two parallel strings, wherein each of the strings have at least two single cells in series. The electrical connecting device provides at least one non-terminal inter-string connection for the purpose of voltage equilibration between series-connected cells or units of cells of the same nominal voltage in parallel strings. The non-terminal inter-string connection may comprise a current-limiting element. A formula is provided for the characteristics of the current-limiting element, depending on voltage and capacity of the units within the electrochemical storage system. The device is based on low-cost electrical components. It decreases voltage differences between sub-units in different parallel strings and increases the reliability and cycle life of any rechargeable electrochemical energy storage system based on series and parallel connections. The device can be used in a modular way for a storage system of any size and complexity.

The present application is a continuation of pending U.S. Ser. No. 60/432,322 filed Dec. 19, 2002.

### BACKGROUND OF THE INVENTION

1. Field of the Invention

The present invention relates to an electrical connecting device for an electrochemical energy storage system, that electrically connects and controls at least two parallel strings of electrochemical storage cells, wherein each of the parallel strings comprises at least two single cells. A device consisting of an arrangement of leads and low cost electrical components is disclosed, which is able to substantially equalize voltages of cells or sub-units in parallel strings. Moreover a formula is provided relating key characteristics of said electrical components and battery parameters such as battery voltage and battery capacity. Such a device has the advantages of maintaining the battery voltage within specified limits, particularly during float charge operation, maximizing battery life, minimizing the number of cell or sub-unit voltages which have to be monitored, being light-weight, of low cost and offering ease of installation.

2. Prior Art

The need for power quality is ever increasing. Current and future sophisticated electric and electronic devices are, and will continue to be, increasingly sensitive to power supply issues. For example, poor power supply and transient power losses in supplied main power can have an adverse impact on electronic equipment. Such power issues can result in the destruction of electronic equipment, the loss of generated data, the loss of communication with other equipment, and the loss of time required to reset and restart procedures that were interrupted by the power failure.

Certain solutions have been developed to provide instantaneous power in response to transient power interruptions and other associated power problems, including uninterruptible power supply (UPS) systems. In such systems, lead-acid batteries are often used to provide temporary power when necessary. While such solutions have had some success, lead-acid batteries have certain problems, including, but not limited to, unsatisfactory cycle life, a high failure rate, high cost of maintenance, high weight, large size, toxicity of the battery materials, risk of hydrogen leaks posing a safety hazard, self discharge issues, and sensitivity to deep discharge and to temperature. Problems of premature failure of a battery system often stem from the fact that such batteries consist of many individual cells connected in series and in parallel. Due to variations in material quality and manufacturing tolerances and due to temperature differences, which can arise at different locations in a large battery, not every cell in a large electrochemical storage system will display exactly the same voltage and deliver the same capacity. Generally such differences become more pronounced with increasing age of a battery. Moreover, it is often the weakest cell in a battery which can lead to premature failure of the entire electrochemical storage system, since charge and discharge voltages may be reached, where corrosion, excessive gas evolution or even destruction or explosion of an entire cell or part of the battery can occur. While electronic control of each individual cell could prevent weaker or faulty cells causing failure of the entire battery, such single cell control is costly, due to extensive electric wiring, data monitoring and processing requirements, in addition to electrical hardware such as power switches. It is therefore an object of this invention to provide a device for minimizing such cost while still increasing battery life time and reliability considerably.

Another important area of application for large electrochemical storage systems is in the automotive industry for hybrid electric vehicles and for a wide range of power assist functions. In addition, there is an increasing array of electrically powered ancillary systems in modern cars, e.g. for preheating catalytic converters, for electric brake or steering force amplifiers, drive by wire, electrically controlled shock absorbers, and the like.

These and other applications for industries, including, but not limited to, car manufacturers and providers of public transport, power quality and power back-up systems, will increasingly require reliable and low-cost storage systems capable of delivering large amounts of electrical power independently of the national grid. In order to fulfill requirements for such power systems, the present invention is directed to an electrochemical energy storage system, such as a rechargeable battery system, wherein a large number of cells is connected in series and in parallel according to principles of this invention.

A specific embodiment of a high power, high voltage lithium-ion battery in bipolar configuration has been disclosed in PCT Application WO 03/085751 A2, entitled “Rechargeable High Power Electrochemical Device”. While the device disclosed herein is suitable to be used in combination with such a battery system, the present invention is not limited to any particular type of battery in terms of battery chemistry, size or design. The device is equally suitable to be used in conjunction with other electrochemical systems such as supercapacitors or fuel cells.

### SUMMARY OF THE INVENTION

The present invention is directed, generally towards rechargeable batteries consisting of a large number of individual cells connected in series and in parallel. A large number of cells means at least four individual cells per battery. The benefits of the present invention become particularly advantageous with increasing number of cells and particularly for batteries of voltages exceeding 10 V.

In standard batteries consisting of individual cells of cylindrical or prismatic design, the required power and voltage output is achieved by connecting single cells electrically in series and/or in parallel. For rechargeable batteries, leads or electrical tabs are normally welded or bolted to the positive and negative terminals of individual cells. It is important that the contact resistance is minimized in order to provide maximum battery run time and minimum generation of heat due to resistive losses. Thus leads, tabs and the like have to be properly dimensioned and they may add significantly to the weight of the entire energy storage system. Thus particular attention has to be paid to such connections.

Commercially available battery packs for applications such as notebook computers consist often of 8, 9 or 12 Li-ion cells. Normally two or three cells are connected in parallel through aforementioned means of tabs and leads. The parallel sub-units are then connected in series to provide a battery pack of nominal voltage of around 10.8 or 14.4 V. The voltage of each sub-group is generally monitored by a microcontroller, assuring that the cell voltages remain within their specified limits.

The object of this invention is to disclose a device, that connects groups of electrochemical cells in parallel in order to achieve an overall electrochemical storage system with higher reliability and lower cost. The electrical connecting device according to the present invention is suited to increase reliability and calendar life of any rechargeable or non-rechargeable electrochemical storage system, such as lead-acid, nickel metal hydride, supercapacitors or fuel cells. In a particularly advantageous embodiment, the battery is based on the Li-ion chemistry, since it is of particular importance that Li-ion cells are kept within tight limits of charge and discharge voltages. Li-ion cells normally contain significant amounts of flammable liquids and solids, while batteries based on aqueous electrolyte solutions generally contain only relatively small amounts of flammable components. Under overcharge, aqueous batteries start to evolve oxygen on the positive electrode, without the battery voltage increasing significantly. Oxygen, evolved under overcharge of such batteries, normally diffuses to the negative electrode and is then recombined in a virtually reversible process. Such a self-regulating overcharge mechanism, inherently limiting the charge voltage, does not exist in the case of Li-ion batteries. Overcharge of Li-ion batteries therefore very quickly results in conditions, where electrode and/or electrolyte materials are no longer stable. In contrast to aqueous batteries, overcharge of Li-ion batteries can lead to irreversible decomposition of battery components, thus creating heat and thereby further accelerating decomposition reactions. Due to the presence of flammable electrolyte solutions in Li-ion batteries, a dangerous situation can rapidly occur under overcharge conditions.

Another particularly advantageous embodiment may consist of batteries of bipolar design. Bipolar batteries consist of at least two, preferably 5-10 or even more cells, which are internally connected in series. Bipolar batteries often provide, in contrast to aforementioned cells of cylindrical or prismatic design, a relatively large footprint in relation to their thickness and a relatively large contact area for the battery terminals. Examples of how to provide series and parallel connections between bipolar units have been disclosed in PCT Application WO 03/085751 A2, entitled “Rechargeable High Power Electrochemical Device”. While series connections of cells and monolithic bipolar units are easily achieved with very low contact resistance, low-resistance parallel connections of single cells are not easily accomplished with the bipolar design. Low-resistance parallel electrical connections of bipolar multicell units can be achieved more readily. They require however relatively large current collection plates and properly dimensioned leads, which significantly add to weight and cost of the electrochemical energy storage device and lower its energy and power density. It is therefore the object of this invention to disclose a low-cost and low-weight electrical connecting device which allows partial to full voltage equilibration and equalization between parallel groups of cells in order to maintain said groups within the voltage limits required for maximum battery reliability and life.

### BRIEF DESCRIPTION OF THE DRAWINGS

FIG. 1 is a generic schematic of an electrochemical storage device consisting of four battery sub-units connected in series;

FIG. 2 is a schematic of an electrochemical storage device consisting of three parallel strings, each of the strings consisting of four series-connected battery sub-units, connected according to the prior art;

FIG. 3 is a schematic of another electrochemical storage device consisting of three parallel strings, each of the strings consisting of four series-connected battery sub-units, connected according to the prior art;

FIG. 4 is a schematic of an electrochemical storage device consisting of three parallel strings, each of the strings consisting of four series-connected battery sub-units, connected in accordance with principles of the present invention;

FIG. 5 is a schematic of another electrochemical storage device consisting of three parallel strings, each of the strings consisting of four series-connected battery sub-units, connected in accordance with principles of the present invention;

FIG. 6 is a graph displaying the sub-unit charge and discharge voltages for cycle 10 and for cycle 300 of EXAMPLE 1 in accordance with principles of the present invention.

FIG. 7 is a graph displaying the sub-unit charge and discharge voltages for cycle 10 and for cycle 300 of COMPARATIVE EXAMPLE.

### DETAILED DESCRIPTION OF THE INVENTION

While this invention is susceptible of embodiments in many different forms, there is shown in the drawings and described herein in detail, several specific embodiments with an understanding that the present disclosure is to be considered as a representation of the principles of the present invention and should not be limited to the embodiments illustrated.

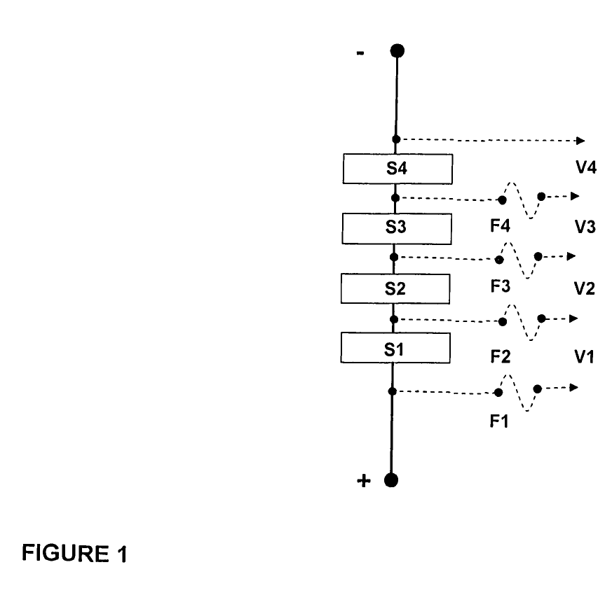

FIG. 1 shows, in a generic way, how four battery sub-units S1-S4 are connected in series to generate the required battery voltage. A sub-unit can be a single cell or a group of series-connected cells. A sub-unit may comprise a bipolar unit containing n cells connected in series. In a preferred embodiment, n is between 5 and 10. An arrangement S1-S4 is called a string. The voltage of each sub-unit is monitored, V1-V4. In order to avoid any accidental short-circuits between monitoring leads, each lead should contain a fuse, F1-F4.

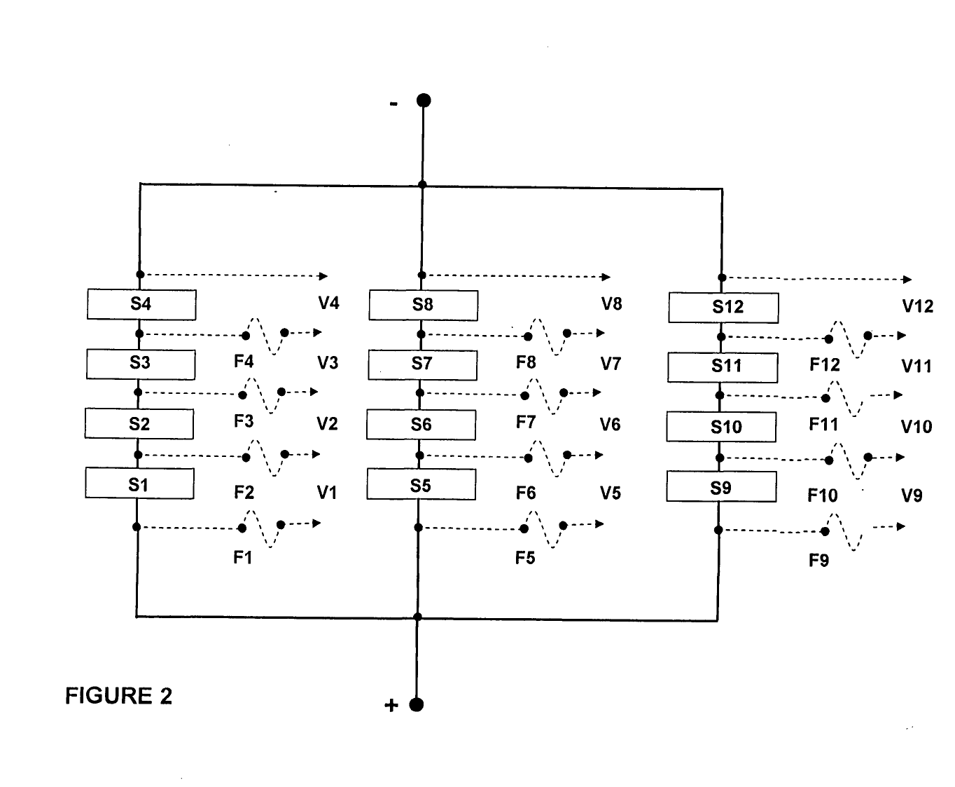

If the power output of one string, shown as an example in FIG. 1, is not sufficient, two or more strings can be connected in parallel. FIG. 2 shows such an arrangement, according to the prior art, where as an example three strings of four sub-units are connected in parallel. The arrangement according to FIG. 2 has the disadvantage that with each added string, more expensive monitoring equipment and more fuses have to be installed. Another disadvantage of such a configuration may become apparent during prolonged operation of the battery system. One of the sub-units S1-S12 in FIG. 2 may display a lower capacity or a higher resistance and, during charge, may reach the specified end-of-charge voltage well before the other sub-units. A voltage monitoring system will detect such an event and will interrupt the charging process, well before the other sub-units are adequately charged. Therefore, a configuration according to FIG. 2 is not able to use the energy storage device to its full capacity. On the other hand, if the battery charge were not interrupted, the voltage of the faulty cell or sub-unit would further increase to levels which are outside the specified range. This could lead to a significantly accelerated battery failure or even present a safety hazard.

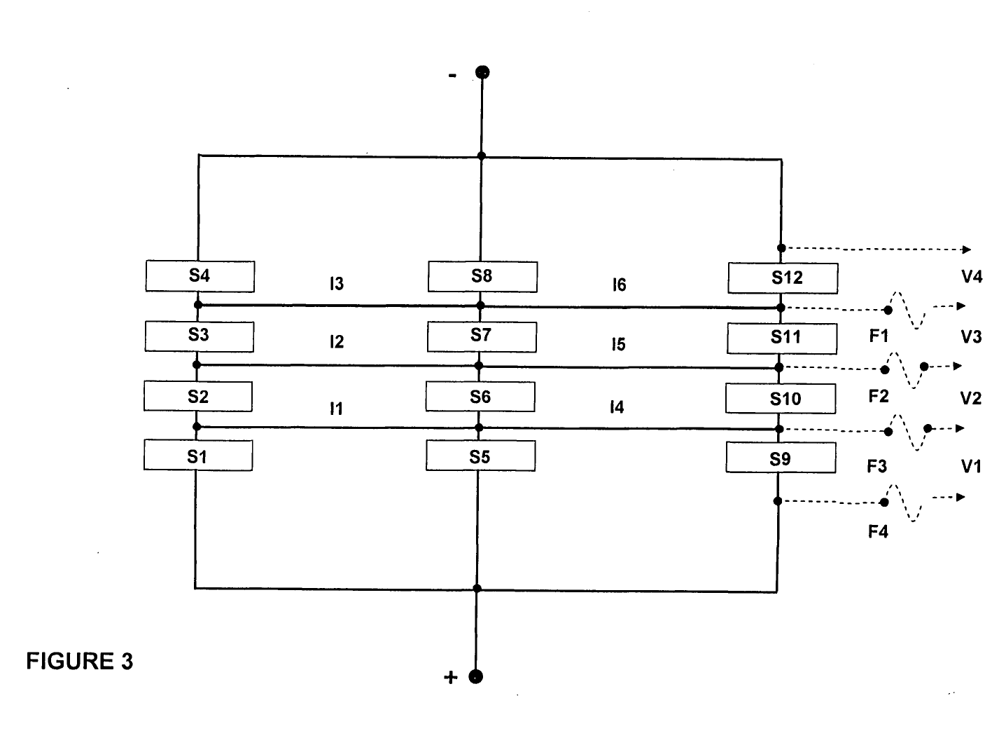

In order to the avoid above-mentioned disadvantages, each string could be charged and discharged through its own electronic circuitry. Such a solution would however significantly add to overall cost of the electrochemical storage system. Alternatively, groups of sub-units could be connected in parallel according to FIG. 3, by introducing additional interconnecting means I1-I6. Said interconnecting means can consist of cables, battery connection tabs, contact elements, current collector plates or a combination thereof An embodiment according to FIG. 3 has the advantage that less voltages need to be monitored, but has the serious disadvantage of allowing significant currents to circulate between strings connected in parallel, particularly if one or several sub-units differ substantially in internal resistance or in effective DC resistance during charge or discharge. Such differences in battery resistance are normally minimized through very tight process control during manufacture. But such differences cannot be entirely excluded and tend to become more pronounced after extensive use of the electrochemical energy storage device. Therefore the interconnecting means have to be able to carry large currents without significant resistive losses, which would lead to unacceptably high and dangerous heat generation. If one assumes, as an example, that sub-unit 1 (S1 in FIG. 3) has a ten times higher effective resistance than all the other units, the current flowing through S5 and S9 will be 10 times higher than the current flowing through S1, instead of the total current, J, provided by the energy storage device being divided equally between the three strings, i.e. each string carrying J/3 and the interconnecting means carrying no current. In the aforementioned example, S1 carries only J/21 while S5 and S9 have to carry 10×J/21 each. Assuming that S2, S6 and S10 have equal resistances, interconnecting means I1 has to carry (J/3−J/21)≈0.286J, i.e. 28.6% of the entire current and interconnecting means I4 has to carry (10J/21−J/3)≈0.143J, i.e. 14.3% of the entire current. In the case of high power storage devices, the total current J could be 100A or higher. Thus relatively heavy interconnecting means, such as power leads and battery connection tabs of adequate cross section would be required. The leads could be electrically connected to the battery terminals by any mechanical fastening technique or any welding or soldering process. Due to the potentially very high currents flowing in an embodiment according to FIG. 3, said connections have to be carefully engineered in order to minimize contact resistance, therefore requiring heavy and costly contacting means. The relative currents carried through the interconnecting means would be even higher if more than one sub-unit displayed a significantly higher resistance. If, for example, S1 and S5 had a ten times higher resistance than all the other sub-units in an embodiment according to FIG. 3, interconnecting means I1 would have to carry 25% of the entire current and I4 50%. While a battery wiring schematic according to FIG. 3 equalizes the voltages of parallel groups of sub-units, i.e. S1-S5-S9, S2-S6-S10, S3-S7-S11 and S4-S8-S12, very effectively, it may lead to very large currents circulating between different battery strings, therefore requiring heavy-duty interconnecting means I1-16. Very large currents circulating between different sub-units would result in very different utilization of sub-units and a configuration according to FIG. 3 would make it difficult to detect serious problems with one or several of the sub-units and may lead to an unsafe condition for the entire battery. Therefore, we will disclose hereunder a device without the disadvantages of heavy-duty interconnections and the risk of large current circulation between partially unbalanced sub-units.

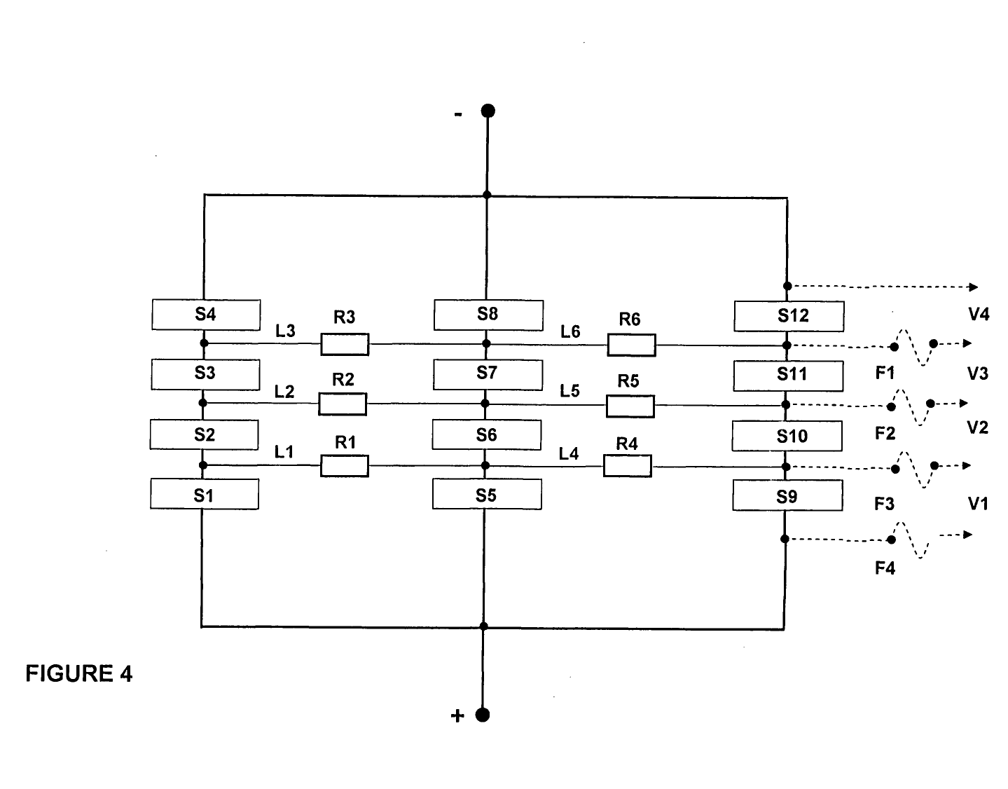

The central idea of this invention is to limit the currents flowing between sub-units in different stings of the electrochemical energy storage system, while still allowing for substantial voltage equilibration and equalization, particularly towards the end of charge and during float charge conditions. FIG. 4 shows how the non-terminal interconnecting means of FIG. 3 are replaced by light-weight leads L1-L6 incorporating a current-limiting element. “Non-terminal interconnection means” are defined within this disclosure as non-terminal in respect to the entire electrochemical storage system; non-terminal interconnecting means are however connected to individual cell terminals or to sub-unit terminals in two different parallel strings, wherein the so-connected cell or sub-unit terminals have at least one further cell between themselves and the two main terminals of the electrochemical storage system.

In preferred embodiments, the current limiting element is a resistor, which could be of the fusible type. These are low-cost and light weight electrical elements. In a further preferred embodiment all resistors Ri (R1 to R6 in the specific example) have the same value and are governed by the formula:
0.04×Vₛᵤ/Cₛᵤ<Ri<8×Vₛᵤ/Cₛᵤ
with Vₛᵤ being the nominal voltage of the subunit and Cₛᵤ (Ah) being its nominal capacity. For a specific example of Vₛᵤ=12.5 V and Cₛᵤ=1 Ah, the resistor shall preferably be larger than 0.5 Ohm but smaller than 100 Ohm. At a voltage difference of 1 V between sub-units in parallel strings, a 0.5 Ohm resistor would lead to a current of 2 A (=2C rate). Such a current is considered as the upper limit for the equalizing current since the heat dissipation in the resistor would be 2 W. Higher wattage resistors become increasingly heavy and expensive. A capacity imbalance of 0.1 Ah can be equalized within 3 minutes if the voltage difference across the equalizing resistor is 1 V.

A 100 Ohm resistor on the other hand, would lead to a current of 0.01 A (0.01C) at a voltage difference of 1 V between sub-units in parallel strings. Such a current is considered as the lower limit for the equalizing current since voltage differences would not be equalized reasonably quickly. A capacity imbalance of 0.1 Ah can be equalized only within 10 hours if the voltage difference across the equalizing resistor is 1 V.

Voltages of the four groups of sub-units, i.e. S1-S5-S9, S2-S6-S10, S3-S7-S11 and S4-S8-S12, in the embodiment according to FIG. 4 will be exactly equalized within each group under steady-state condition, e.g. under float charge conditions, where the overall current decreases to a very small value. During operation at high power levels, some voltage differences between various sub-units are normally acceptable. It is however most important that the voltage differences are minimized towards the end of charge. If full voltage monitoring of single sub-units is required by a particular application, the device according to FIG. 4 still has the very large advantage, in comparison to a device according to FIG. 3, of limiting current flow between parallel strings. As mentioned above, unlimited current flow between parallel strings would lead to significantly different utilization levels of sub-units and potentially to a hazardous situation.

For ease of assembly, the resistors can be of the surface mount type. Moreover the resistors can be of the fusible resistor type in order to safeguard against overload of the resistor or the leads in case of extreme voltage imbalance, e.g. in the case of a short circuit or another serious problem of one or several of the sub-units. The fusible resistors may be selected in a way that the interconnecting means are interrupted if the voltage imbalance is larger than 10 or 20% or any acceptable percentage of the nominal voltage. The exact value depends on the specific battery system and its sensitivity to voltages outside the specified voltage range.

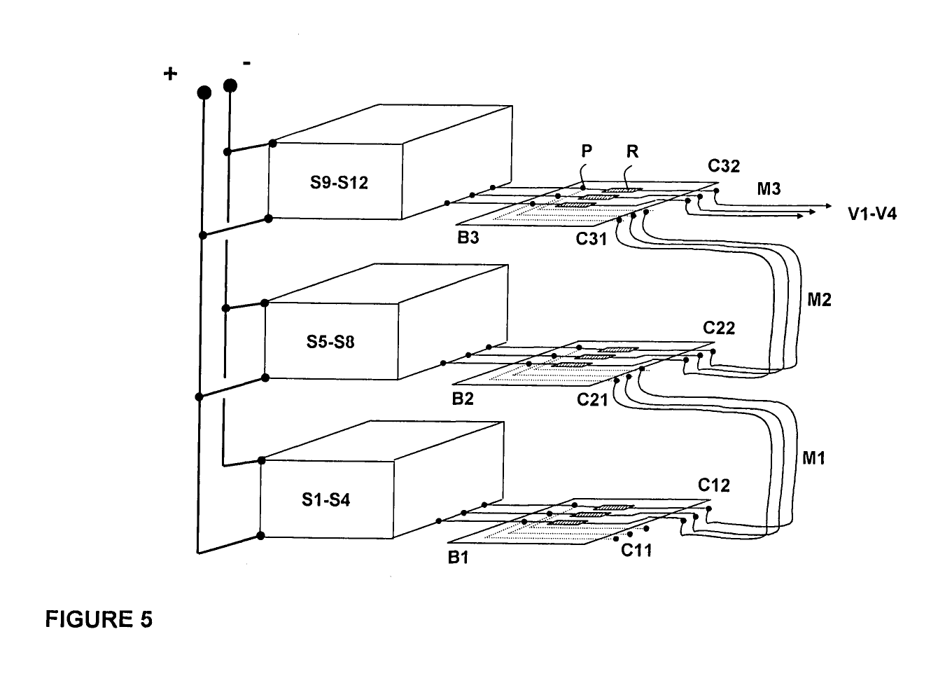

In a preferred embodiment, voltage monitoring means such as cables, leads or tabs consisting of aluminum, copper, nickel or any suitable combination thereof are attached to the two terminals of each sub-unit. Said voltage monitoring means are further attached to one or several printed circuit boards by a soldering or welding process or any other process known to those skilled in the art. FIG. 5 schematically shows an embodiment comprising printed circuit boards in conjunction with a battery configuration according to FIG. 4. For reasons of cost and ease of interchangeability, all circuit boards may be identical. FIG. 5 shows as an example such an embodiment with three identical circuit boards, B1-B3, each containing suitable soldering or welding pads P, where the battery leads for voltage equilibration can be attached. Further, each circuit board contains the equalizing resistors R and the necessary means for establishing electrical connections between individual printed circuit boards. Such means can be connectors C11-C32 and leads M1-M3. Leads can consist of an arrangement of cables, multi-core cables or flexible ribbon cables. Since circuit board B3 of an embodiment according to FIG. 5 does not, in principle, require the equalizing resistors R, circuit board B3 may be different from the others. Alternatively, all the resistors and connectors can be mounted on one circuit board or be attached directly to one or several sub-units or to any suitable part of the energy storage system. The circuitry may further contain fuses, indicators for the state of the battery such as LEDs or LCDs, integrated circuits, switches, or any electrical or electronic arrangement to monitor or to manage sub-units or the entire electrochemical energy storage system. They may further include circuitry that triggers an event after any of the fusible resistors has been overloaded. The triggered event may be an optical and/or acoustic warning signal, display of an error message or disconnection of part of the battery or of the entire battery. The full benefit of an electrical connecting device in accordance with principles of this invention becomes particularly apparent if more than the 12 battery sub-units S1-S12, shown in FIG. 5, have to be connected in series and parallel. An electrical connecting device according to the present invention is entirely modular, can be “daisy-chained” to suit an electrochemical storage device of any size and complexity and can be mass-produced at low cost.

The principles of the invention described above, and specifically claimed herein, were used to assemble an electrical connecting device, consistent with the above description, in combination with an electrochemical storage system. However, the present disclosure is not intended to limit the invention to any of the particularly disclosed structures, except insofar as the appended claims are so limited.

In order to construct an example according to principles of the present invention and a comparative example, six identical standard sub-units, S1-S3 and S1′-S3′, were assembled, hereafter referred to as “regular sub-units”. Two additional sub-units, S4 and S4′, hereafter referred to as “weakened sub-units”, were assembled, including a deliberate defect.

For each regular sub-unit, a cathode end plate, an anode end plate and four bipolar plates were prepared. Each cathode end plate consisted of an aluminum substrate plate coated with a mixture of Li_{1.05}Cr_{0.10}Mn_{1.90}O₄, carbon black and binder on an area of 500 cm². Each anode end plate consisted of an aluminum substrate plate coated with a mixture of Li₄Ti₅O₁₂, carbon black and binder on an area of 500 cm². Each bipolar plate consisted of an aluminum substrate plate coated on one side with a mixture of Li_{1.05}Cr_{0.10}Mn_{1.90}O₄, carbon black and binder on an area of 500 cm², and coated on the other side, in registration with the first side, with a mixture of Li₄Ti₅O₁₂, carbon black and binder on an area of 500 cm². For each sub-unit, one cathode end plate, four bipolar plates, one anode end plate and 5 sheets of microporous separator membrane were stacked on top of each other to create 5 series-connected cathode/separator/anode cells in a bipolar configuration, with the aluminum side of the cathode end plate facing downwards and the aluminum side of the anode end plate facing upwards. Three sides of the perimeter of the six electrode substrate plates were sealed using thermofusible frames of a thermoplastic material. An appropriate amount of nonaqueous electrolyte solution was injected into each of the five cells in order to thoroughly wet out the electroactive areas and the separator membranes, before the fourth side of the perimeter was sealed hermetically under vacuum, thereby resulting in a regular sub-unit of 12.5 V nominal voltage and 0.9 Ah nominal capacity.

In order to better demonstrate the benefits of the electrical connecting device according to this invention, two weakened sub-units, S4 and S4′, of 12.5 V nominal voltage and 0.9 Ah nominal capacity were prepared, including a defect which caused a lowered capacity and an increased resistance of one cell within each of the two sub-units. The defect consisted of a thin insulating 70×70 mm sheet of PTFE being placed in the center of each of the top cells of sub-units S4 and S4′, thereby blocking close to 10% of the active area of one of the cells in each of the two sub-units. This introduction of this defect was the only difference between the weakened sub-units, S4 and S4′, and the regular sub-units S1-S3 and S1′-S3′.

### EXAMPLE 1

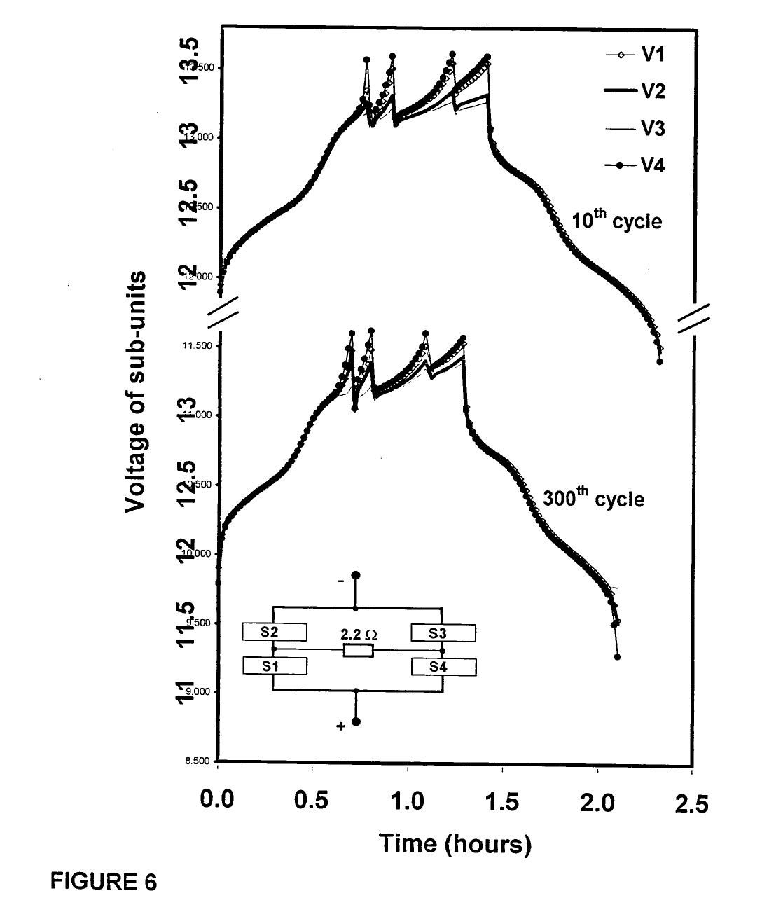

Three regular 12.5 V/0.9 Ah sub-units, S1-S3, and one weakened 12.5 V/0.9 Ah sub-unit S4 were connected in series and in parallel according to the arrangement illustrated in the insert in FIG. 6 to form a 25 V/1.8 Ah rechargeable electrochemical energy storage system. Inclusion of a sub-unit with one weakened cell simulates a battery, in which one sub-unit displays a higher resistance, particularly towards the end of charge, and slightly different charge and discharge characteristics. A first sheet of nickel foam of 500 cm² size was placed on the bottom of a first string terminal plate of positive polarity, consisting of 1 mm thick aluminum of 500 cm² size, with a 20 mm wide tab for the attachment of the cathode terminal cable and monitoring leads. A first regular 12.5 V/0.9 Ah sub-unit S1 was placed, with its cathode end plate facing downwards, on top of the first sheet of nickel foam. A second sheet of nickel foam of 500 cm² size, comprising a first non-terminal inter-string connection cable, was then placed on top of the anode end plate of the first 12.5 V/0.9 Ah sub-unit. A second regular 12.5 V/0.9 Ah sub-unit S2 was placed, with its cathode end plate facing downwards, on top of the second sheet of nickel foam, followed by a third sheet of nickel foam of 500 cm² size, followed by the string terminal plate of negative polarity, consisting of 1 mm thick aluminum of 500 cm² size, with a 20 mm wide tab for the attachment of the anode terminal cable and monitoring leads. A fourth sheet of nickel foam of 500 cm² size was then placed on top of the string terminal plate of negative polarity, followed by a third regular 12.5 V/0.9 Ah sub-unit S3, with its anode end plate facing downwards, followed by a fifth sheet of nickel foam of 500 cm² size, comprising a second non-terminal inter-string connection cable. Finally, a weakened 12.5 V/0.9 Ah sub-unit S4 was placed, with its anode end plate facing downwards, on top of the fifth sheet of nickel foam, followed by a sixth sheet of nickel foam of 500 cm² size, followed by a second string terminal plate of positive polarity, consisting of 1 mm thick aluminum of 500 cm² size, with a 20 mm wide tab.

The tabs of the first and the second string terminal plates of positive polarity were bolted together and a cathode terminal cable was attached to one of them. An anode terminal cable was attached to the tab of the string terminal plate of negative polarity. A 2.2 Ohm/5 W resistor was connected in between the first and the second non-terminal inter-string connection cable, resulting as EXAMPLE 1, in a 25 V/1.8 Ah electrochemical storage system comprising an electrical connecting device in accordance to principles of this invention. EXAMPLE 1 comprises means for voltage equilibration and for voltage monitoring of each of the four sub-units, i.e. the two system terminals and the two non-terminal inter-string connection cables, connected together by a resistor. The voltages of the sub-units S1-S3 are designated V1-V3, whereas the voltage of the sub-unit S4 is designated V4. The electrical configuration of EXAMPLE 1 is shown schematically as an insert in FIG. 6.

The electrochemical storage system of EXAMPLE 1 was placed under a compression of 1.5 kg/cm² and then charged with a current of 2 A until the first of the sub-units reached 13.5 V. The charging current was then reduced to 1 A, then to 0.4 A and finally to 0.2 A, each time after the first of the sub-units had reached 13.5 V. Then the battery was discharged at 2 A until the first of the sub-units reached 11 V. This charge and discharge cycle was repeated 300 times.

FIG. 6 shows the charge and discharge voltages V1-V4 for cycles 10 and 300. As expected, it was always the weakened sub-unit, which reached the charge and the discharge voltage limit first. The voltage difference with respect to the regular sub-unit S1, i.e. the sub-unit having its voltage equilibrated in conjunction with weakened sub-unit S4, was however relatively small and remained rather small over 300 cycles. The data showed that the largest voltage difference between V4 and V1 during charge was 0.26V. With the voltage equalizing resistor of 2.2 Ohm used in EXAMPLE 1, this corresponds to a maximum equalizing inter-string current of 0.18 A, or to a rate of 0.2C per sub-unit. This means that close to 60% of the total charge current of 2 A flow through the regular unit S1 while the weakened unit S4 is only charged with close to 40% of the charge current towards the end of the 2 A charge step. Although an equalizing current of 0.18 A does not seem very high, it was obviously sufficiently high to successfully protect the weakened sub-unit from continued overcharge since the energy storage system according to this EXAMPLE showed relatively high stability during continued charge and discharge cycles, despite containing a simulated defect. The battery capacity was reduced by only 0.3 Ah from 1.9 Ah initially to 1.6 Ah after 300 complete charge and discharge cycles, thus showing the benefit of an electrical connecting device according to the present invention. The maximum voltage difference between S1 and S4 of 0.26V corresponds to 2% of the nominal voltage only. Therefore reduced voltage monitoring from four to two voltages only is justified, i.e. either V1 and V2 or V3 and V4, thus further demonstrating the benefits of an electrical connecting device according to the present invention

### Comparative Example

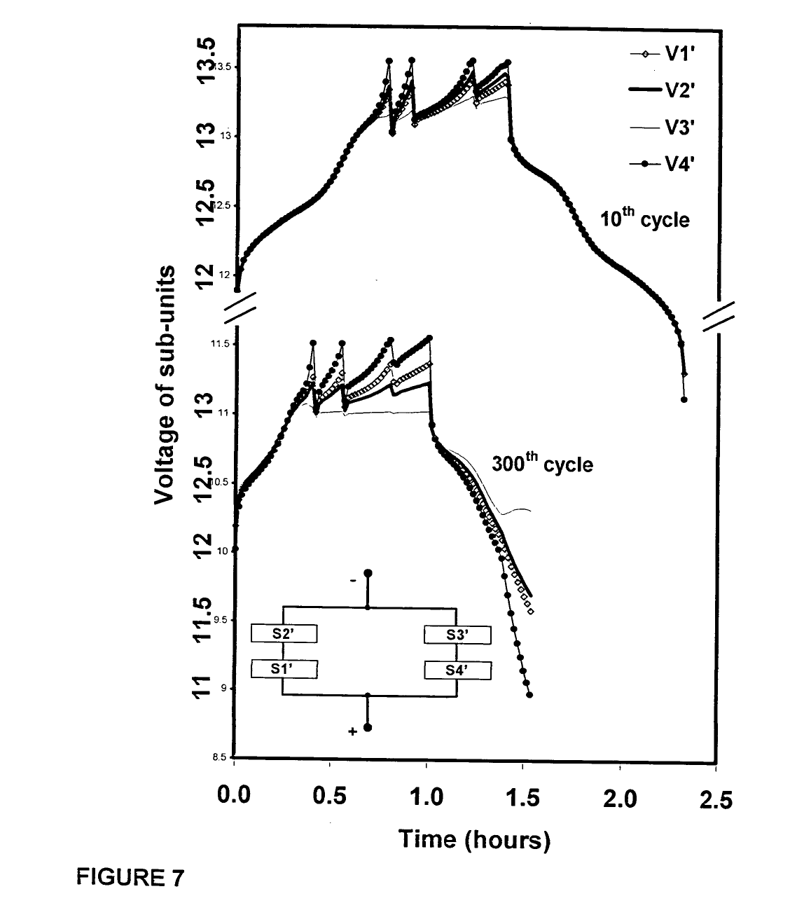

Three regular 12.5 V/0.9 Ah sub-units, S1′-S3, and one weakened 12.5 V/0.9 Ah sub-unit S4′ were connected in series and in parallel according to the arrangement illustrated in the insert in FIG. 7 to form a 25 V/1.8 Ah rechargeable electrochemical energy storage system. Inclusion of a sub-unit with one weakened cell simulates a battery, in which one sub-unit displays a higher resistance, particularly towards the end of charge, and slightly different charge and discharge characteristics. A first sheet of nickel foam of 500 cm² size was placed on the bottom of a first string terminal plate of positive polarity, consisting of 1 mm thick aluminum of 500 cm² size, with a 20 mm wide tab for the attachment of the cathode terminal cable and monitoring leads. A first regular 12.5 V/0.9 Ah sub-unit S1′ was placed, with its cathode end plate facing downwards, on top of the first sheet of nickel foam. A second sheet of nickel foam of 500 cm² size, comprising a first non-terminal voltage monitoring cable, was then placed on top of the anode end plate of the first 12.5 V/0.9 Ah sub-unit. A second regular 12.5 V/0.9 Ah sub-unit S2′ was placed, with its cathode end plate facing downwards, on top of the second sheet of nickel foam, followed by a third sheet of nickel foam of 500 cm² size, followed by the string terminal plate of negative polarity, consisting of 1 mm thick aluminum of 500 cm² size, with a 20 mm wide tab for the attachment of the anode terminal cable and monitoring leads. A fourth sheet of nickel foam of 500 cm² size was then placed on top of the string terminal plate of negative polarity, followed by a third regular 12.5 V/0.9 Ah sub-unit S3′, with its anode end plate facing downwards, followed by a fifth sheet of nickel foam of 500 cm² size, comprising a second non-terminal voltage monitoring cable. Finally, a weakened 12.5 V/0.9 Ah sub-unit S4′ was placed, with its anode end plate facing downwards, on top of the fifth sheet of nickel foam, followed by a sixth sheet of nickel foam of 500 cm² size, followed by a second string terminal plate of positive polarity, consisting of 1 mm thick aluminum of 500 cm² size, with a 20 mm wide tab.

The tabs of the first and the second string terminal plates of positive polarity were bolted together and a cathode terminal cable was attached to one of them. An anode terminal cable was attached to the tab of the string terminal plate of negative polarity, resulting as COMPARATIVE EXAMPLE, in a 25 V/1.8 Ah electrochemical storage system without an electrical connecting device in accordance to principles of this invention. The electrochemical storage system according to COMPARATIVE EXAMPLE comprises no means for voltage equilibration. It comprises however means for voltage monitoring of each of the four sub-units, i.e. leads to the two system terminals and the two non-terminal voltage monitoring cables. The voltages of the sub-units S1′-S3′ are designated V1′-V3′, whereas the voltage of the sub-unit S4′ is designated V4′. The electrical configuration of COMPARATIVE EXAMPLE is shown schematically as an insert in FIG. 7.

The electrochemical storage system of COMPARATIVE EXAMPLE was placed under a compression of 1.5 kg/cm² and then charged with a current of 2 A until the first of the sub-units reached 13.5 V. The charging current was then reduced to 1 A, then to 0.4 A and finally to 0.2 A, each time after the first of the sub-units had reached 13.5 V. Then the battery was discharged at 2 A until the first of the sub-units reached 11 V. This charge and discharge cycle was repeated 300 times.

FIG. 7 shows the charge and discharge voltages V1′-V4′ for cycles 10 and 300. As expected, it was always the weakened sub-unit S4′, which reached the charge and the discharge voltage limit first. In contrast to EXAMPLE 1, all four voltages V1′-V4′ differed from each other considerably, particularly towards the end of charge and discharge. The voltage differences became significantly higher with increasing cycle numbers. The data showed that the largest voltage differences occurred between V3′ and V4′, which amounted during charge to values as high as 0.92 V, corresponding to more than 7% of the nominal voltage of a sub-unit. While the weakened unit S4′ was overcharged in each cycle, unit S3′ was not charged enough, since the sum of V3′+V4′ had to correspond to the sum of V1′+V2′ within the configuration of COMPATATIVE EXAMPLE. Thus, the voltages V1′ and V2′ “compromised” to a level between V3′ and V4′, without too much deviation between them. It was the unfavorable interplay between V1′ to V4′, which resulted, in contrast to EXAMPLE 1, in a relatively high capacity fade during continued charge and discharge cycles. Without the electrical connecting device of the present invention, the battery capacity was reduced by 0.8 Ah from 1.9 Ah initially to 1.1 Ah after 300 complete charge and discharge cycles.

During discharge, the voltage deviation between V3′ and V4′ was even larger and amounted to differences as high as 1.4 V, i.e. S4′ had reached the cut-off voltage of 11 V, while S3′ was discharged to 12.4 V only. FIG. 7 shows how the voltage of the weakened unit S4′ dropped very steeply towards the end of discharge after 300 cycles. It is known that the effective battery resistance increases significantly if one cell or one electrode becomes practically exhausted. Due to the increased resistance in the second string, i.e. S3′-S4′, of the storage system according to COMPARATIVE EXAMPLE, the discharge current was forced to a larger extent to travel through the first string, i.e. S1′-S2′, leading to insufficient utilization of the regular unit S3′ towards the end of discharge, as indicated by the unusual increase of V3′ towards the end of discharge. Such unwanted and difficult-to-control effects of damaging current distribution between entire parallel strings can be successfully suppressed by utilizing the electrical connecting device of the present invention, which uses the voltage characteristics of regular units to impress favorable voltage conditions on those with a defect or weakness.

The foregoing description merely explains and illustrates the invention and the invention is not limited thereto except insofar as the appended claims are so limited, as those skilled in the art who have the disclosure before them will be able to make modifications without departing from the scope of the invention.

1. An electrical connecting device for a rechargeable electrochemical energy storage system, the electrical device comprising a means of providing voltage equilibration between series-connected energy storage sub-units arranged in parallel strings.

2. The device according to claim 1, wherein the means of providing voltage equilibration consists of at least one non-terminal electrically conducting inter-string connection between two points of equivalent nominal voltage in two parallel strings of series-connected energy storage sub-units.

3. The device according to claim 2, wherein the at least one non-terminal electrically conducting inter-string connection contains a current-limiting element.

4. The device according to claim 3, wherein the current-limiting element is a resistor.

5. The device according to claim 3, wherein the current-limiting element is a resistor of the fusible type.

6. The device according to claim 2, wherein all of the at least one non-terminal inter-string connections are of the same resistance.

7. The device according to claim 6, wherein, if each energy storage sub-unit has a nominal voltage equal to Vₛᵤ and a nominal capacity equal to Cₛᵤ, then the resistance R of each of the non-terminal inter-string connections is selected according to the formula
0.04×Vₛᵤ/Cₛᵤ<R<8×Vₛᵤ/Cₛᵤ.

8. A rechargeable electrochemical energy storage system consisting of:
a. at least two parallel strings of series-connected energy storage sub-units; and
b. an electrical connecting device comprising a means of providing voltage equilibration between series-connected energy storage sub-units arranged in parallel strings.

9. The system according to claim 8, wherein the means of providing voltage equilibration consists of at least one non-terminal terminal electrically conducting inter-string connection between two points of equivalent nominal voltage in two parallel strings of series-connected energy storage sub-units.

10. The system according to claim 9, wherein the at least one non-terminal electrically conducting inter-string connection contains a current-limiting element.

11. The system according to claim 10, wherein the current-limiting element is a resistor.

12. The system according to claim 10, wherein the current-limiting element is a resistor of the fusible type.

13. The system according to claim 10, wherein all of the at least one non-terminal inter-string connections are of the same resistance.

14. The system according to claim 13, wherein, if each energy storage sub-unit has a nominal voltage equal to Vₛᵤ and a nominal capacity equal to Cₛᵤ, then the resistance R of each of the non-terminal inter-string connections is selected according to the formula
0.04×Vₛᵤ/Cₛᵤ<R<8×Vₛᵤ/Cₛᵤ.

15. The system according to claim 10, wherein the series-connected energy storage sub-units each comprise a single electrochemical cell.

16. The system according to claim 10, wherein the series-connected energy storage sub-units each comprise at least two cells in series.

17. The system according to claim 10, wherein the series-connected energy storage sub-units are of the Li-ion type.

18. The system according to claim 10, wherein the series-connected energy storage sub-units are of bipolar design.

19. The system according to claim 18, wherein each sub-unit of bipolar design contains between 5 and 10 cells in series.

20. The system according to claim 10, wherein all series-connected energy storage sub-units have the same nominal voltage and the same nominal capacity.

21. The system according to claim 18, wherein the series-connected energy storage sub-units of bipolar design are connected in series within each parallel string by means of contact elements.

22. The system according to claim 21, wherein each of the non-terminal inter-string connections of the electrical connecting device is attached to a pair of contact elements, located at non-terminal points of equivalent nominal voltage in parallel strings of series-connected energy storage sub-units.

23. The system according to claim 22, wherein the non-terminal inter-string connections are attached to the contact elements by a welding, soldering, or crimping process.

24. The system according to claim 21, wherein the contact elements comprise light-weight electrically conducting mats, such as metallized foam or fiber mats.

25. The system according to claim 22, wherein string terminal sub-units of bipolar design are contacted by contact elements and string terminal plates, with all string terminal plates of the one polarity electrically connected to each other and all string terminal plates of the other polarity electrically connected to each other.

26. The system according to claim 25, wherein m parallel strings of the electrochemical energy storage system, with m being an even number of at least 2, are arranged in a parallel configuration characterized by a stack configuration, where
a. strings with consecutive numbers follow each other in the stack;
b. sub-units of odd-numbered strings face their one polarity in one direction;
c. sub-units of even-numbered strings face their one polarity in the other direction;
d. strings with consecutive numbers are electrically contacted among themselves by m−1 units of contact element/string terminal plate/contact element;
e. the first string terminal plate is of the one polarity, is positioned at the one end of the stack and electrically contacts a contact element, which itself electrically contacts the first string;
f. the last string terminal plate is of the one polarity, is positioned at the other end of the stack and electrically contacts a contact element, which itself electrically contacts the last string;
g. the first and the last string terminal plates of the one polarity are in electrical contact to each of the other (m/2−1) terminal plates of the one polarity within the stack; and
h. the m/2 terminal plates of the other polarity within the stack are each in electrical contact to each other.

27. The system according to claim 25, wherein n parallel strings of the electrochemical energy storage system, with n being an odd number of at least 3, are arranged in a parallel configuration characterized by a stack configuration, where
a. strings with consecutive numbers follow each other in the stack;
b. sub-units of odd-numbered strings face their one polarity in one direction;
c. sub-units of even-numbered strings face their one polarity in the other direction;
d. strings with consecutive numbers are electrically contacted among themselves by n−1 units of contact element/string terminal plate/contact element;
e. the first string terminal plate is of the one polarity, is positioned at the one end of the stack and electrically contacts a contact element, which itself electrically contacts the first string;
f. the last string terminal plate is of the other polarity, is positioned at the other end of the stack and electrically contacts a contact element, which itself electrically contacts the last string;
g. the first string terminal plate of the one polarity is in electrical contact to each of the other (n−1)/2 terminal plates of the one polarity within the stack; and
h. the last string terminal plate of the other polarity is in electrical contact to each of the other (n−1)/2 terminal plates of the other polarity within the stack.

28. The system according to claim 22, wherein each of the non-terminal inter-string connections between the n^{th} and the (n+1)^{th} string comprises:
a. a cable being attached to a non-terminal contact element within the n^{th} string and to a circuit board; and
b. another cable being attached to a the non-terminal contact element of equivalent nominal voltage within the (n+1)^{th} string and the same circuit board.

29. The system according to claim 28, wherein the circuit board contains at least one current-limiting element and at least two connections to:
a. either two non-terminal points of equivalent nominal voltage in two parallel strings; or
b. one non-terminal point within a string and to the voltage monitoring means.

30. The system according to claim 10, wherein the electrochemical energy storage system, comprising
a. p parallel strings, wherein each of the strings have s sub-units connected in series; and
b. [(p−1)×(s−1)] non-terminal inter-string connections comprises means to monitor not more than s voltages.

31. The system according to claim 10, wherein the electrochemical energy storage system, comprising
a. p parallel strings, wherein each of the strings have s sub-units connected in series; and
b. [(p−1)×(s−1)] non-terminal inter-string connections, comprises s−1 circuit boards of the same design.

32. The system according to claim 28, wherein the circuit boards are connected to each other in a modular way by ribbon cables.
